(19) United States
(12) Patent Application Publication
(10) Pub. No.: US 2010/0174950 A1
(43) Pub. Date: Jul. 8, 2010

(54) METHOD AND SECURE MODULE FOR COMMUNICATION WITH HOST, METHOD AND APPARATUS FOR COMMUNICATION WITH SECURE MODULE, METHOD AND APPARATUS FOR CONTROLLING SECURE MODULE

(75) Inventors: Young-Min PARK, Seongnam-si (KR); Jun-Ho JANG, Hwaseong-si (KR); Keum-Yong OH, Yongin-si, (KR); Hae-Su GWON, Gunpo-si (KR); Gyung-Pyo HONG, Yongin-si (KR); Young-Soo KANG, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/727,859

(22) Filed: Mar. 19, 2010

Related U.S. Application Data
(63) Continuation of application No. PCT/KR2008/001658, filed on Mar. 25, 2008.
(60) Provisional application No. 60/989,248, filed on Nov. 20, 2007.

(51) Int. Cl. H04L 9/00; G06F 11/07

(52) U.S. Cl. 714/48; 380/255; 714/E11.024

(57) ABSTRACT

A method of communicating with a host in a security module providing information necessary for decrypting encrypted broadcast data received by the host, includes if an event occurs, characterizing the event as an event that a user of the host is to be notified about with regard to the decryption of the encrypted broadcast data, generating a user notification message including information about the event that occurred; and transmitting the user notification message to the host.

### CROSS-REFERENCE TO RELATED APPLICATIONS

This application is a continuation of International Patent Application No. PCT/KR2008/001658, filed on Mar. 25, 2008, in the Korean Intellectual Property Office, which claims priority from U.S. Provisional Patent Application No. 60/989,248, filed on Nov. 20, 2007, in the U.S. Patent and Trademark Office, the disclosures of which are incorporated herein in their entirety by reference.

### TECHNICAL FIELD

Apparatuses and methods consistent with the present invention relate to a security module for performing communication with a host, performing communication with the security module, and controlling the security module, and more particularly, to a security module for performing communication with a host that receives broadcast data through a cable network, performing communication with the security module, and controlling the security module.

### BACKGROUND

Digital broadcasting, such as a terrestrial broadcast, a satellite broadcast, and an existing medium such as a cable broadcast, has rapidly spread. Such digital broadcasting involves an innovative change in the environment of the broadcasting industry.

Digital broadcasting service providers may encrypt and transmit specific content only to users who pay additional fees to view the content. In this case, a user who pays an additional fee to view encrypted content installs a module used to decode the encrypted content provided by a digital broadcast service provider and obtains information necessary for decoding the encrypted content via the module so as to view the encrypted content. A conditional access system (CAS) is a system by which viewing of content is limited, such as charging a fee or setting an age limit to view paid content.

In the meantime, users must subscribe to a cable broadcast service to receive it, pay additional fees for a paid service, and have a TV or a settop box for processing encrypted broadcast data, which is defined by the OpenCable broadcast standard.

Security modules used to provide information necessary for decrypting encrypted cable broadcast data are designed to use cable cards. However, cable cards are expensive and have a variety of types according to technologies applied. To address this problem, software provided by each service provider is mounted on a hardware based security module having minimum functionality.

FIG. 1 is a block diagram of a related art CAS system used by a cable broadcast. Referring to FIG. 1, a broadcast receiver 120 is internally or externally connected to a hardware based security module 130. The security module 130 includes a CAS client provided by a security server 112 that a service provider operates.

The service provider transfers encrypted broadcast data, an entitlement management message (EMM), and an entitlement control message (ECM) via a headend 110 to the broadcast receiver 120. If the broadcast receiver 120 transmits the EMM and ECM to the CAS client, the CAS client generates a decryption key. The broadcast receiver 120 uses the generated decryption key to decrypt the encrypted broadcast data so as to provide a broadcast service to a user.

However, the broadcast service may not be provided due to an error that occurs when a security module generates the decryption key. In this case, the user does not have a solution for resolving the error since the user cannot know an error has occurred. Also, the headend 110 initializes the security module and deletes a security client just when the headend 110 and the security client communicate with each other. However, such an operation causes a serious problem when the user is beyond a service area of the service provider that provides the security client.

For example, when the user moves from an area A to an area B, a service provider that provides a service in the area A and a service provider that provides a service in the area B may differ from each other. In this regard, the security client cannot communicate with the service provider that provides the service in the area B. In particular, if the security client is mounted on the security module, the security module cannot perform a basic operation such as channel scanning or free scanning in order to apply a security policy defined between the security client and the service provider to a broadcast receiver. Therefore, the user must replace security modules or go to a broadcasting station of the area A and delete the security client.

### SUMMARY

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method, apparatus, and security module for providing a user with information about an occurrence of an error, and a method and apparatus for effectively controlling the security module.

According to an aspect of the present invention, there is provided a method of communicating with a host in a security module providing information necessary for decrypting encrypted broadcast data received by the host, the method comprising: if an event that is established as an event that a user of the host is to be notified about with regard to the decryption of the broadcast data occurs, generating a user notification message including information about the event that occurred; and transmitting the user notification message to the host.

The security module may be a hardware based module and include a software based security client distributed from an external server providing the encrypted broadcast data, wherein the encrypted broadcast data is received by the host via a cable network.

The event may occur when an error regarding the security module occurs.

The event may occur when the security module or the security client is upgraded.

The user notification message may comprise at least one of information about the event that occurred, information about the type of the event that occurred, information about output conditions that are conditions for outputting the information about the event that occurred, information about whether to store the information about the event that occurred, and information about the data size of the user notification message.

According to another aspect of the present invention, there is provided a method of communicating with a security module providing information necessary for decrypting encrypted broadcast data, the method comprising: receiving a user notification message indicating that an event that is established as an event that a user is to be notified about with regard to the decryption of the broadcast data occurs from the security module; and outputting information about the event that occurred, included in the user notification message.

The user notification message may comprise information about output conditions that are conditions for outputting the information about the event that occurred, wherein the outputting of the information comprises: outputting the information about the event that occurred, when the outputting conditions are satisfied.

The security module may be a hardware based module and include a software based security client distributed from an external server providing the encrypted broadcast data, wherein the encrypted broadcast data is received via a cable network.

The event may occur when an error regarding the security module occurs.

The event may occur when the security module or the security client is upgraded.

The user notification message may comprise at least one of information about the type of the event that occurred, information about whether to store the information about the event that occurred, and information about the data size of the user notification message.

According to another aspect of the present invention, there is provided a security module providing information necessary for decrypting encrypted broadcast data received by a host and communicating with the host, the security module comprising: a message generating unit, if an event that is established as an event that a user of the host is to be notified about with regard to the decryption of the broadcast data occurs, generating a user notification message including information about the event that occurred; and a transmitting unit transmitting the user notification message to the host.

According to another aspect of the present invention, there is provided an apparatus for communicating with a security module providing information necessary for decrypting encrypted broadcast data, the apparatus comprising: a receiving unit receiving a user notification message indicating that an event that is established as an event that a user is to be notified about with regard to the decryption of the broadcast data occurs from the security module; and an outputting unit outputting information about the event that occurred, included in the user notification message.

According to another aspect of the present invention, there is provided a method of controlling a security module providing information necessary for decrypting first broadcast data encrypted by using a first method, the method comprising: receiving second broadcast data encrypted by using a second method and information about the second broadcast data; determining whether the security module provides information necessary for decrypting the second broadcast data based on the information about the second broadcast data; and selectively controlling the security module to delete a first security client that is included in the security module and provides the information necessary for decrypting the first broadcast data based on a result of the determining.

The method may further comprise: receiving upgrade data for including a second security client providing the information necessary for decrypting the second broadcast data in the security module; and controlling the second security client to be included in the security module by using the upgrade data.

The first security client may be a software based module distributed by a service provider providing the first broadcast data, wherein the security module is a hardware based module used to drive the first security client, and wherein the second broadcast data is received via a cable network.

According to another aspect of the present invention, there is provided a method of controlling a security module providing information necessary for decrypting encrypted broadcast data, the method comprising: receiving a signal instructing initialization of the security module; and if the signal is received, controlling the security module to delete a software based security client providing the information necessary for decrypting the encrypted broadcast data.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a related art conditional access system (CAS) system used by a cable broadcast;

FIG. 2 is a block diagram of a security module that communicates with a host according to an exemplary embodiment of the present invention;

FIG. 3 is a block diagram of a communication apparatus according to an exemplary embodiment of the present invention;

FIG. 4 is a block diagram of a system comprising a security module and a communication apparatus according to an exemplary embodiment of the present invention;

FIG. 5 is a data flow diagram of a message processing operation performed by a communication system according to an exemplary embodiment of the present invention;

FIG. 6 is a flowchart illustrating a method of communication between a security module and a host in view of the security module according to an exemplary embodiment of the present invention;

FIG. 7 is a flowchart illustrating a method of communication between a security module and a host in view of the host according to an exemplary embodiment of the present invention;

FIG. 8A is a block diagram of a control apparatus according to an exemplary embodiment of the present invention;

FIG. 8B is a block diagram of a control apparatus according to another exemplary embodiment of the present invention;

FIG. 9 is a data flow diagram of an operation performed by the control apparatus shown in FIG. 8A according to an exemplary embodiment of the present invention;

FIG. 10 is a data flow diagram of an operation performed by the control apparatus shown in FIG. 8B according to an exemplary embodiment of the present invention;

FIG. 11A is a flowchart illustrating a method of controlling a security module according to an exemplary embodiment of the present invention; and

FIG. 11B is a flowchart illustrating a method of controlling a security module according to another exemplary embodiment of the present invention.

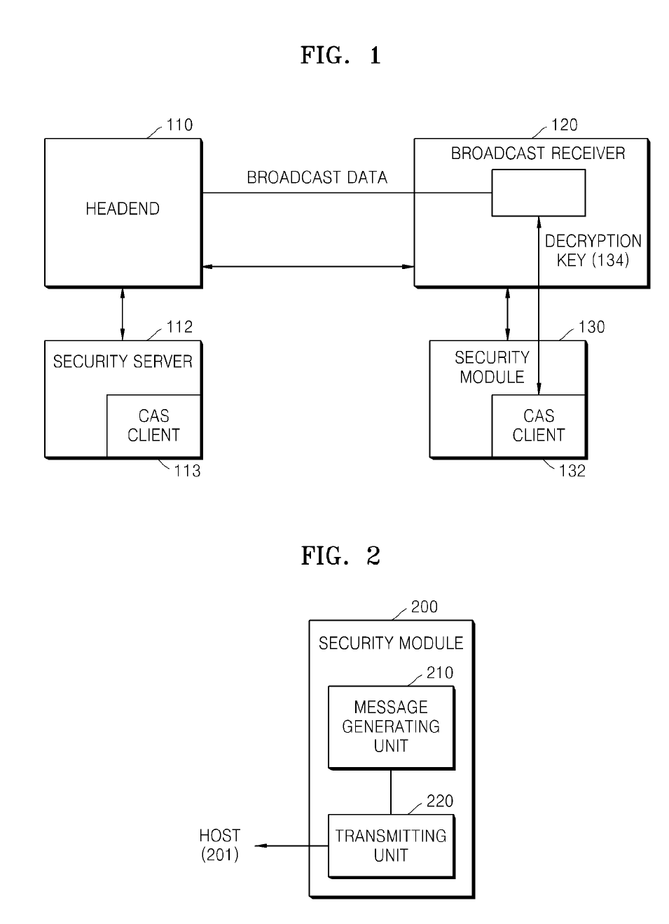

### DETAILED DESCRIPTION OF EXEMPLARY EMBODIMENTS

Hereinafter, the present invention will be described in detail by explaining exemplary embodiments of the invention with reference to the attached drawings.

FIG. 2 is a block diagram of a security module 200 that communicates with a host 201 according to an exemplary embodiment of the present invention. Referring to FIG. 2, the security module 200 provides the host 201 with information necessary for decrypting encrypted broadcast data received by the host 201, and communicates with the host 201. The security module 200 comprises a message generating unit 210 and a transmitting unit 220.

If it has been established that a host user is to be notified about an event and the event occurs, the message generating unit 210 generates a user notification message including information about the event. The event may relate to the decryption of the encrypted broadcast data. The security module 200, which may be a hardware based module, may include a software based security client received from an external server (not shown) that provides the encrypted broadcast data.

The message generating unit 210 registers the event that the host user is to be notified about in advance, and, if the event occurs, generates the user notification message.

A case, which the host user needs to be notified about, may be registered in advance. For example, if an error occurs in the security module 200, a case where the security module 200 is upgraded or a security client is upgraded is established as the occurrence of the event.

In this case, the user notification message includes information about the error that occurred and information about the event that occurred, such as a version of the security module 200 or improved performance thereof, a version of the security client or improved performance thereof, etc.

An error may occur in the security module 200 when the security module 200 executes the security client, fails to authenticate the host 201 and the service provider (not shown), does not generate a decryption key, fails to user authenticate the host 201 and the security module 200, and updates the security client, and the like. However, the event is not limited thereto but various types of events may be established according to exemplary embodiments.

Table 1 below concerns a data structure of the user notification message.

TABLE 1

Information about an event that occurred
Information about the type of event that occurred
Information about the output conditions
Information about the data size
Storage information

The user notification message may include at least one of information about an event that occurred, information about the type of event that occurred, information about the output conditions, information about the data size, and storage information.

The information about an event that occurred is a brief description of the event that occurred, so as to inform the user about the event that occurred.

The information about the type of event that occurred includes a description of the type of an occurred event.

According to the information about the type of event that occurred, the type of error that occurs during execution of the security client may be “0x00”, the type of an error that occurs during downloading of the security client may be “0x01”, the type of an error that occurs during an authentication process may be “0x02”, the type of an error that occurs when the user does not subscribe to the service provider may be “0x03”, and the type of an error that occurs when user information, such as a user's age, does not meet a predetermined requirement may be “0x04”.

The information about the output conditions includes information about conditions for outputting the information about an event that occurred, such as whether and when to output the information about the event that occurred, etc. The information about the event that occurred may be output immediately when received or at a specific status according to the importance thereof.

The information about the data size includes the data size of the user notification message.

The storage information includes information about whether to store the information about the event that occurred, in the host 201.

The transmitting unit 220 transmits the user notification message to the host 201.

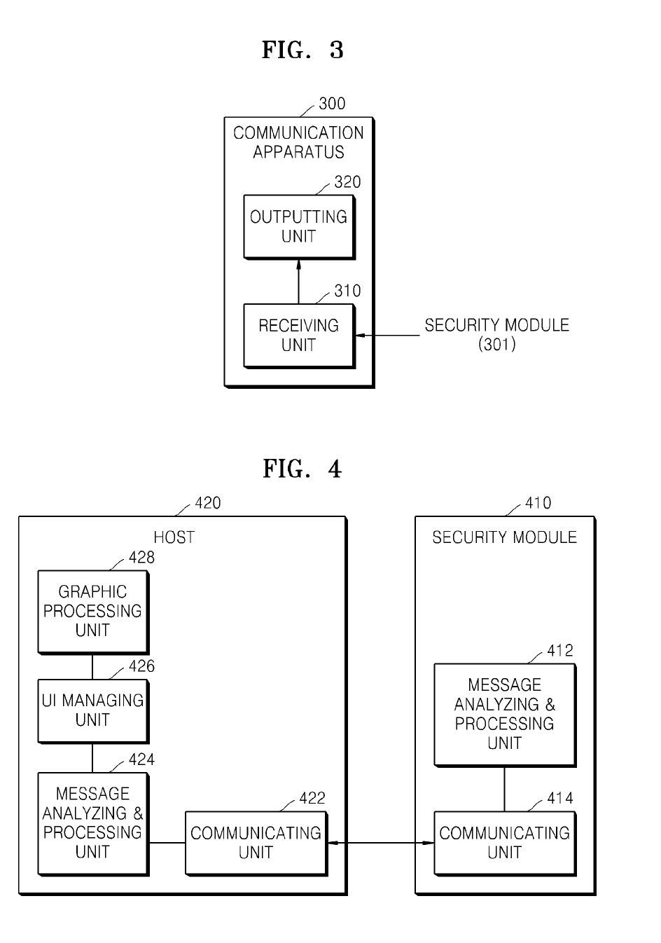

FIG. 3 is a block diagram of a communication apparatus 300 according to an exemplary embodiment of the present invention. Referring to FIG. 3, the communication apparatus 300 receives encrypted broadcast data from an external server operated by a service provider via a cable network, and communicates with a security module 301 that provides information necessary for decrypting the encrypted broadcast data. The security module 301, which may be a hardware based module, may include a software based security client received from an external server that provides the encrypted broadcast data.

The communication apparatus 300 may comprise a receiving unit 310 and an outputting unit 320. The receiving unit 310 receives a user notification message from the security module 301. The user notification message concerns the decryption of the encrypted broadcast data and is generated according to the occurrence of an event that is established as being one that a user is to be notified about.

The user notification message includes information about an event that occurred, which is to be output.

Also, the user notification message may further comprise at least one of information about the output condition including conditions for outputting information about an event that occurred, information about whether to store the information about the event that occurred, and information about the data size of the user notification message. In particular, when the user notification message further comprises the information about the output conditions, the outputting unit 320 outputs the information about the event that occurred, when the output conditions are satisfied.

The outputting unit 320 outputs the information about the event that occurred, included in the user notification message. The outputting unit 320 may be realized as a display device to display the information about the event that occurred, or may be realized as an audio device such as a speaker to output the information about the event that occurred, as sound.

The communication apparatus 300 may further comprise a transmitting unit (not shown) that transmits the user notification message to an external server. When an error occurs in the security module 301 and the user notification message is generated, it is necessary to perform an operation for correcting the error.

FIG. 4 is a block diagram of a system 400 comprising a security module 410 and a communication apparatus host 420 according to an exemplary embodiment of the present invention. Referring to FIG. 4, the security module 410 comprises a message analyzing & processing unit 412 and a communicating unit 414.

The message analyzing & processing unit 412 analyzes and processes a message received from the host 420. The message analyzing & processing unit 412 is involved with the decryption of broadcast data and generates a user notification message if an event that is established as one that the user of the host 420 is to be notified about occurs. Examples of the event that is established as one that the user is to be notified about are an error occurring during execution of a security client, a user authentication failing when the user changes a channel to an encrypted channel, an authentication failing between the host 420 and the security module 410, an error occurring during an upgrading of the security client, and the like. Thus, various types of events may be established according to exemplary embodiments.

The communicating unit 414 of the security module 410 communicates with a communicating unit 422 of the host 420 and transmits the user notification message.

The host 420 comprises the communicating unit 422, a message analyzing & processing unit 424, a user UI managing unit 426, and a graphic processing unit 428. The communicating unit 422 of the host 420 communicates with the communicating unit 414 of the security module 410 and receives the user notification message.

The message analyzing & processing unit 424 processes the user notification message received by the communicating unit 422, and, if the message analyzing & processing unit 424 determines that it is necessary to display the user notification message for the user, transmits the user notification message to the user UI managing unit 426. If the user UI managing unit 426 transmits the user notification message to the graphic processing unit 428, the graphic processing unit 428 displays the information about an event that occurred, included in the user notification message. Therefore, the user receives information about a current status and takes an appropriate measure to the information.

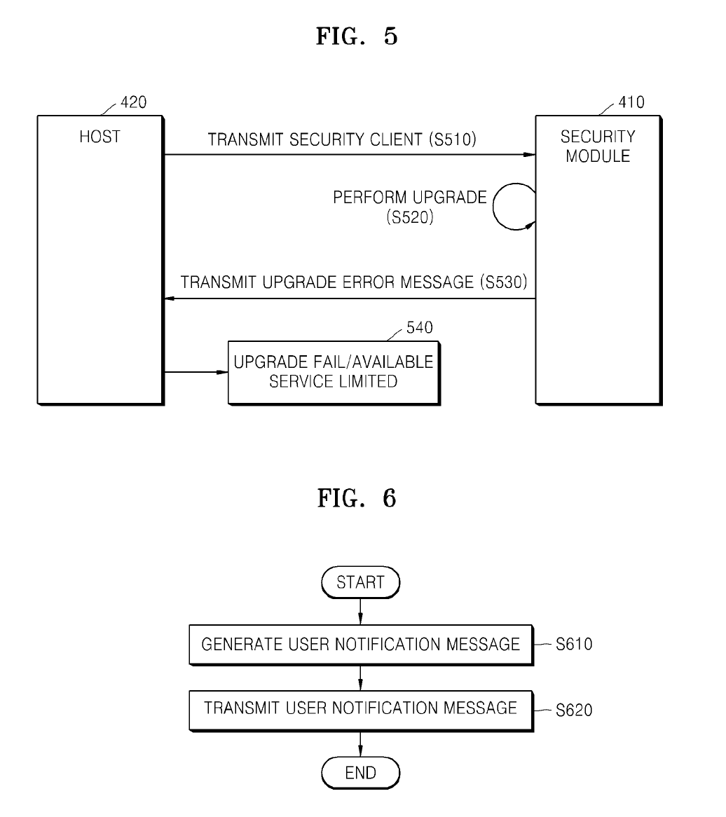

FIG. 5 is a data flow diagram of a message processing operation performed by a communication system according to an exemplary embodiment of the present invention. Referring to FIG. 5, when an error occurs while a security module 510 upgrades a security client included therein, the security module transmits a user notification message to the host 420, and the host 420 processes the user notification message.

In operation S510, the host 420 receives data necessary for upgrading the security client from a service provider (not shown) and transmits the data to the security module 410.

In operation S520, the security module 410 uses the received data to upgrade the security client. Hereinafter, it is assumed that the security module 410 fails to upgrade the security client, and thus it is established to notify a user of the host 420 of such a failure. Thus, the security module 410 generates the user notification message informing the user about the failure in upgrading the security client.

In operation S530, the security module 410 transmits the user notification message including information about an upgrade error to the host 420.

The host 420 processes the received user notification message and displays the processed user notification message on a display window 540. Therefore, the display window 540 displays the user notification message “upgrade failed, available service limited”.

FIG. 6 is a flowchart illustrating a method of communication between a security module and a host in view of the security module according to an exemplary embodiment of the present invention. Referring to FIG. 6, the security module may be a hardware based module, and include a software based security client distributed by an external server that provides encrypted broadcast data. The encrypted broadcast data is transmitted to the host via a cable network.

In operation S610, the security module determines if an event that is established as one that a user of the host is to be notified about occurs with regard to the decryption of the encrypted broadcast data. If the event occurs, the security module generates a user notification message including information about the event. According to exemplary embodiments, various types of events may be established to generate the user notification message. For example, the event may be established when an error with the security module occurs, the security module or the security client is upgraded, and the like.

The user notification message may further comprise, in addition to information about the event that occurred, at least one of information about the type of the event that occurred, information about the output conditions including conditions for outputting information about the event that occurred, information about whether to store the information about the event that occurred, and information about the data size of the user notification message.

In operation S620, the security module transmits the user notification message to the host.

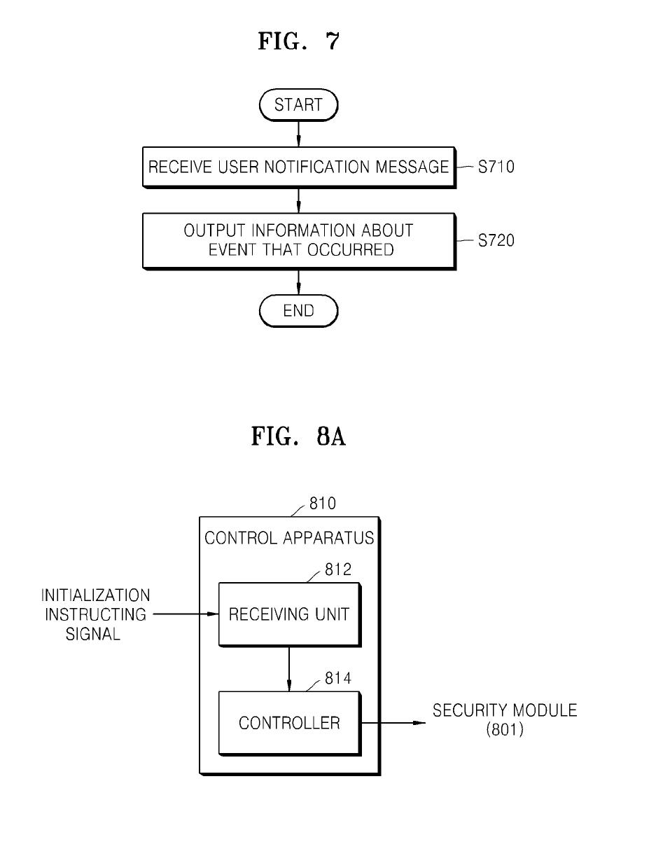

FIG. 7 is a flowchart illustrating a method of communication between a security module and a host in view of the host according to an exemplary embodiment of the present invention. Referring to FIG. 7, in operation S710, the host receives a user notification message informing the user about the occurrence of an event that is established as one that a user is to be notified about with regard to the decryption of broadcast data from the security module.

In operation S720, the host outputs information about the event included in the user notification message. The user notification message may further comprise information about the output conditions including conditions for outputting information about the event that occurred. In this case, the host determines if the outputting conditions are satisfied and outputs information about an event that occurs when the outputting conditions are satisfied in operation S720.

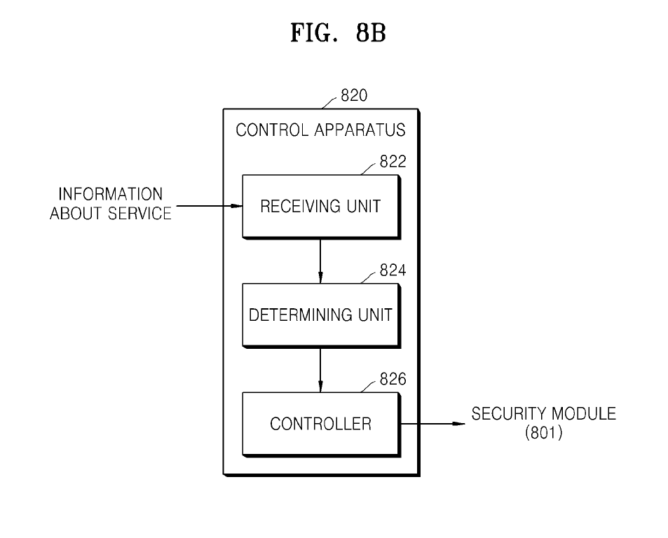

FIG. 8A is a block diagram of a control apparatus 810 according to an exemplary embodiment of the present invention. Referring to FIG. 8A, the control apparatus 810 of the present embodiment controls a security module 801 that provides information necessary for decrypting encrypted broadcast data and comprises a receiving unit 812 and a controller 814. The control apparatus 810 receives the encrypted broadcast data via a cable network.

The receiving unit 812 receives a signal used to instruct initialization of the function of the security module 801 from the outside. The receiving unit 812 receives the signal via manipulation of a remote controller or a button attached to a TV set.

The controller 814 receives the signal and deletes all security clients included in the security module 801 so that the security module 801 is initialized. The security clients are software based modules providing information necessary for decrypting the encrypted broadcast data and are operated by the security module 801.

FIG. 8B is a block diagram of a control apparatus 820 according to another exemplary embodiment of the present invention. Hereinafter, for descriptive convenience, broadcast data that is encrypted using a first method by a service provider A and is transmitted via a cable network is referred to as a first broadcast data, and broadcast data that is encrypted using a second method by a service provider B and is transmitted via the cable network is referred to as a second broadcast data. Also, a security client distributed by the service provider A is referred to as a first security client, and a security client distributed by the service provider B is referred to as a second security client.

The control apparatus 820 of an exemplary embodiment controls the security module 801 that provides information necessary for decrypting the first broadcast data encrypted by using the first method and comprises a receiving unit 822, a determining unit 824, and a controller 826.

The receiving unit 822 receives the second broadcast data encrypted by using the second method and information about the second broadcast data. The information about the second broadcast data may include electronic program guide (EPG) information, information about a service construction such as channel data, and service information.

The determining unit 824 determines if the security module can provide information necessary for decrypting the second broadcast data based on the information about the second broadcast data. If a user moves from an area to another area and thus a service provider is changed, a method of encrypting broadcast data is changed. If the user moves from an area where the service provider A provides a service to another area where the service provider B provides the service, the first security client cannot decrypt the second broadcast data.

The controller 826 controls the security module to delete the first security client providing the information necessary for decrypting the first broadcast data based on a result of the determination. In more detail, if previously provided service information differs from currently provided service information, and if it is impossible to receive audio and video or communicate with a service provider by using currently provided broadcast data, the controller 826 controls initialization of the security module 801.

If it is possible to communicate with a current service provider, the controller 826 requests the current service provider to upgrade a security client.

In this case, the receiving unit 822 further receives upgrade data used to include the second security client providing the information necessary for decrypting the second broadcast data in the security module 801. The second security client is distributed by the current service provider. Also, the controller 826 further controls the second security client to be included in the security module 801 by using the upgrade data.

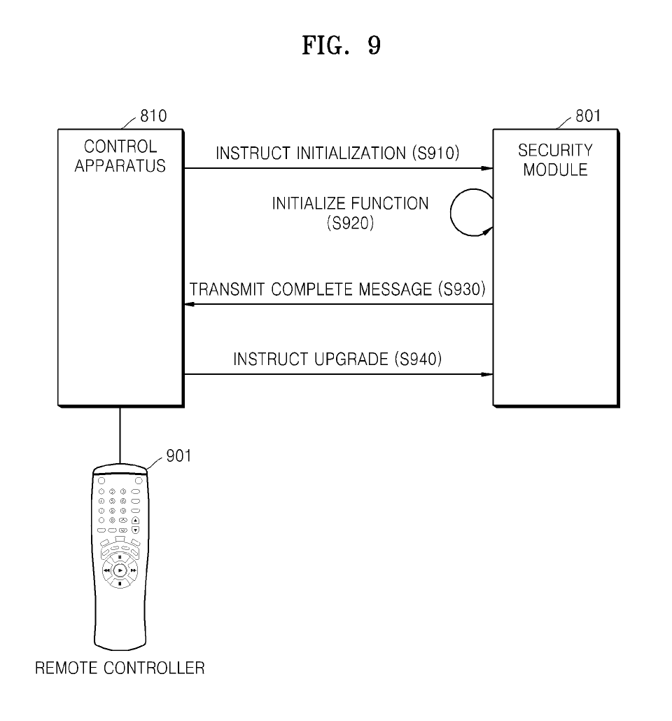

FIG. 9 is a data flow diagram of an operation performed by the control apparatus 810 shown in FIG. 8A according to an exemplary embodiment of the present invention. Referring to FIG. 9, a security client is beyond an area where broadcast data can be decrypted and thus a user manually deletes the security client. It is assumed that the user requests initialization of the security module 801 by using a remote controller 901 or a specific button.

In operation 5910, the control apparatus 810 requests the security module to be initialized. In more detail, opencable application platform (OCAP) middleware that receives a user's request transmits a signal instructing deletion of all security clients included in the security module 801 to the security module 801.

In operation 5920, the security module 801 deletes all security clients included therein and is initialized. In more detail, the security module 801 receives the signal instructing deletion of all security clients, and a boot loader of the security module 801 deletes all security clients included in the security module 801.

In operation 5930, the security module 801 transmits a message indicating that the security module 801 is initialized to the control apparatus 810. The security module 801 is reset after all security clients are deleted.

In operation 5940, the control apparatus 810 downloads a new security client and transmits the new security client to the security module 801.

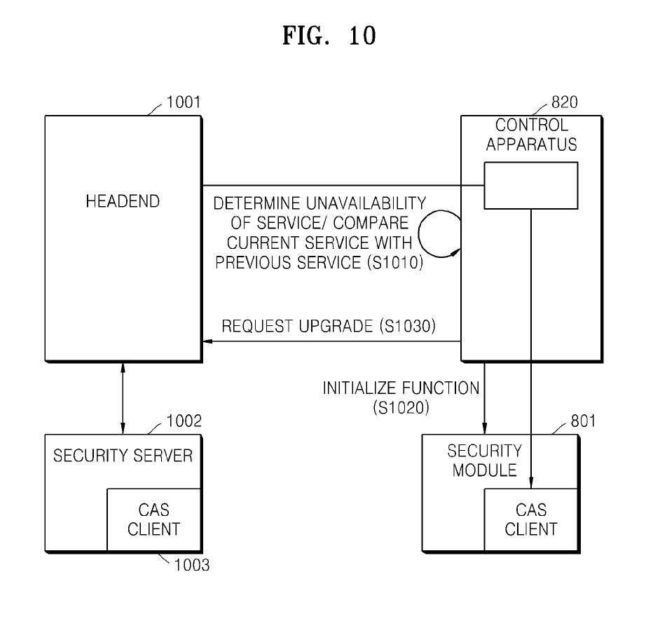

FIG. 10 is a data flow diagram of an operation performed by the control apparatus 820 shown in FIG. 8B according to an exemplary embodiment of the present invention. Referring to FIG. 10, in operation S1010, the control apparatus 820 receives broadcast data from a headend 1001, determines whether to provide a broadcast service by using a security client, compares a previously provided service with a currently received service, and determines whether to initialize the security module 801.

In operation S1020, if the control apparatus 820 determines that the broadcast service is not provided by using the security client included in the security module 801, the control apparatus 820 requests the security module 801 to be initialized. The security module 801 deletes the security client included therein.

In operation S1030, the control apparatus 820 requests the headend 1001 for a new security client. Thereafter, the control apparatus 820 controls the security module 801 to include the new security client distributed by a security server 1002 therein.

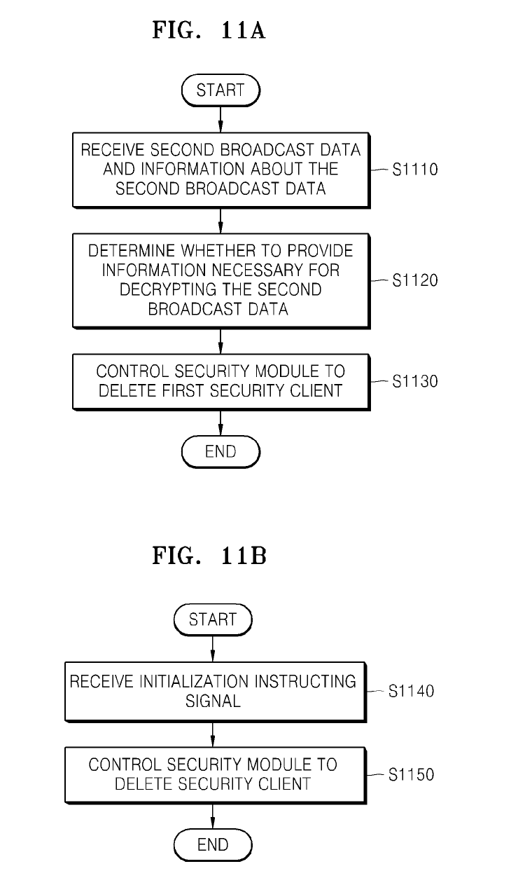

FIG. 11A is a flowchart illustrating a method of controlling a security module according to an exemplary embodiment of the present invention. Initially, the security module includes a first security client providing information necessary for decrypting first broadcast data encrypted by using a first method.

Referring to FIG. 11A, in operation S1110, second broadcast data encrypted by using a second method and information about the second broadcast data are received.

In operation S1120, it is determined whether to provide information necessary for decrypting the second broadcast data received by the security module based on the information about the second broadcast data.

In operation S1130, the security module is selectively controlled so as to delete the first security client that is included in the security module and provides the information necessary for decrypting the first broadcast data based on a result of the determination.

FIG. 11B is a flowchart illustrating a method of controlling a security module according to another exemplary embodiment of the present invention. The security module includes a software based security client providing information necessary for decrypting broadcast data.

Referring to FIG. 11B, in operation S1140, a signal instructing initialization of the security module is received from the outside.

In operation S1150, if the signal is received, the security module is controlled to delete the software based security client included therein.

In the present disclosure, a type of a message that is to be used between a host and a security module may be determined so that a user can promptly confirm and resolve errors that occur in a decryption process. Both the user and the host can effectively control the security module.

Exemplary embodiments of the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

Alternatively, exemplary embodiments of the present invention can be embodied as computer readable codes on a computer readable transmission medium. Examples of the computer readable transmission medium include carrier waves (such as data transmission through the Internet).

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed:

1. A method of communicating with a host in a security module providing information necessary for decrypting encrypted broadcast data received by the host, the method comprising:
if an event occurs, the event being characterized as an event that a user of the host is to be notified about with regard to the decryption of the encrypted broadcast data, generating a user notification message including information about the event that occurred; and
transmitting the user notification message to the host.

2. The method of claim 1, wherein the security module is a hardware based module and includes a software based security client distributed from an external server providing the encrypted broadcast data,
wherein the encrypted broadcast data is received by the host via a cable network.

3. The method of claim 2, wherein the event occurs when an error regarding the security module occurs.

4. The method of claim 2, wherein the event occurs when the security module or the security client is upgraded.

5. The method of claim 3, wherein the user notification message comprises at least one of information about the event that occurred, information about a type of the event that occurred, information about output conditions that are conditions for outputting the information about the event that occurred, information about whether to store the information about the event that occurred, and information about a data size of the user notification message.

6. A method of communicating with a security module providing information necessary for decrypting encrypted broadcast data, the method comprising:
receiving a user notification message from the security module indicating that an event occurs, the event being characterized as an event that a user is to be notified about with regard to the decryption of the encrypted broadcast data; and
outputting information about the event that occurred, the information being included in the user notification message.

7. The method of claim 6, wherein the user notification message comprises information about outputting conditions that are conditions for outputting the information about the event that occurred,
wherein the outputting of the information comprises: outputting the information about the event that occurred, when the outputting conditions are satisfied.

8. The method of claim 6, wherein the security module is a hardware based module and includes a software based security client distributed from an external server providing the encrypted broadcast data,
wherein the encrypted broadcast data is received via a cable network.

9. The method of claim 8, wherein the event occurs when an error regarding the security module occurs.

10. The method of claim 8, wherein the event occurs when the security module or the security client is upgraded.

11. The method of claim 6, wherein the user notification message comprises at least one of information about a type of the event that occurred, information about whether to store the information about the event that occurred, and information about a data size of the user notification message.

12. A security module providing information necessary for decrypting encrypted broadcast data received by a host and communicating with the host, the security module comprising:
a message generating unit that, if an event occurs, the event being characterized as an event that a user of the host is to be notified about with regard to the decryption of the encrypted broadcast data, generates a user notification message including information about the event that occurred; and
a transmitting unit that transmits the user notification message to the host.

13. The security module of claim 12, wherein the security module is a hardware based module and includes a software based security client distributed from an external server providing the encrypted broadcast data,
wherein the encrypted broadcast data is received by the host via a cable network.

14. The security module of claim 13, wherein the event occurs when an error regarding the security module occurs.

15. The security module of claim 13, wherein the event occurs when the security module or the security client is upgraded.

16. The security module of claim 14, wherein the user notification message comprises at least one of information about the event that occurred, information about a type of the event that occurred, information about output conditions that are conditions for outputting the information about the event that occurred, information about whether to store the information about the event that occurred, and information about a data size of the user notification message.

17. An apparatus for communicating with a security module providing information necessary for decrypting encrypted broadcast data, the apparatus comprising:
a receiving unit that receives a user notification message from the security module indicating that an event occurs, the event being characterized as an event that a user is to be notified about with regard to the decryption of the encrypted broadcast data; and
an outputting unit that outputs information about the event that occurred, the information being included in the user notification message.

18. The apparatus of claim 17, wherein the user notification message comprises information about outputting conditions that are conditions for outputting the information about the event that occurred,
wherein the outputting unit outputs the information about the event that occurred, when the outputting conditions are satisfied.

19. The apparatus of claim 17, wherein the security module is a hardware based module and includes a software based security client distributed from an external server providing the encrypted broadcast data,
wherein the encrypted broadcast data is received via a cable network.

20. The apparatus of claim 19, wherein the event occurs when an error regarding the security module occurs.

21. The apparatus of claim 19, wherein the event occurs when the security module or the security client is upgraded.

22. The apparatus of claim 17, wherein the user notification message comprises at least one of information about a type of the event that occurred, information about whether to store the information about the event that occurred, and information about a data size of the user notification message.

23. A method of controlling a security module providing information necessary for decrypting first broadcast data encrypted by using a first method, the method comprising:
receiving second broadcast data encrypted by using a second method, and receiving information about the second broadcast data;
determining whether the security module provides information necessary for decrypting the second broadcast data based on the information about the second broadcast data; and
selectively controlling the security module, based on a result of the determining, to delete a first security client that is included in the security module and provides the information necessary for decrypting the first broadcast data.

24. The method of claim 23, further comprising:
receiving upgrade data for including a second security client providing the information necessary for decrypting the second broadcast data in the security module; and
controlling the second security client to be included in the security module by using the upgrade data.

25. The method of claim 23, wherein the first security client is a software based module distributed by a service provider providing the first broadcast data,
wherein the security module is a hardware based module used to drive the first security client, and
wherein the second broadcast data is received via a cable network.

26. A method of controlling a security module providing information necessary for decrypting encrypted broadcast data, the method comprising:
receiving a signal instructing initialization of the security module; and
if the signal is received, controlling the security module to delete a software based security client providing the information necessary for decrypting the encrypted broadcast data.

27. An apparatus for controlling a security module providing information necessary for decrypting first broadcast data encrypted by using a first method, the apparatus comprising:
a receiving unit that receives second broadcast data encrypted by using a second method, and receiving information about the second broadcast data;
a determining unit that determines whether the security module provides information necessary for decrypting the second broadcast data based on the information about the second broadcast data; and
a controller that selectively controls the security module, based on a result of the determining, to delete a first security client that is included in the security module and provides the information necessary for decrypting the first broadcast data.

28. The apparatus of claim 27, wherein the receiving unit receives upgrade data for including a second security client providing the information necessary for decrypting the second broadcast data in the security module; and
wherein the controller controls the second security client to be included in the security module by using the upgrade data.

29. The apparatus of claim 27, wherein the first security client is a software based module distributed by a service provider providing the first broadcast data,
wherein the security module is a hardware based module used to drive the first security client, and
wherein the second broadcast data is received via a cable network.

30. An apparatus for controlling a security module providing information necessary for decrypting encrypted broadcast data, the apparatus comprising:
a receiving unit that receives a signal instructing initialization of the security module; and
a controller that, if the signal is received, controls the security module to delete a software based security client providing the information necessary for decrypting the encrypted broadcast data.

31. A computer readable recording medium having recorded thereon a program for executing the method of claim 1.

32. A computer readable recording medium having recorded thereon a program for executing the method of claim 6.

33. A computer readable recording medium having recorded thereon a program for executing the method of claim 23.

34. A computer readable recording medium having recorded thereon a program for executing the method of claim 26.
